(19) United States
(12) Patent Application Publication
(10) Pub. No.: US 2025/0151942 A1
(43) Pub. Date: May 15, 2025

(54) AUTOMATED APPARATUS AND METHOD FOR PREPARING HOT BEVERAGES

(71) Applicant: Ashish Sudhir Mitra, Sydney NSW (AU)

(72) Inventor: Ashish Sudhir Mitra, Sydney NSW (AU)

(21) Appl. No.: 18/836,032

(22) PCT Filed: Feb. 16, 2023
(86) PCT No.: PCT/AU2023/050104

§ 371 Date: Aug. 6, 2024

(30) Foreign Application Priority Data
Feb. 16, 2022 (AU) 2022900337

(51) Int. Cl. A47J 27/21; A47J 27/62; A47J 31/18; A47J 31/52; A47J 31/60; H05B 3/68; H05B 6/12

(52) U.S. Cl. CPC A47J 27/21066; A47J 27/21041; A47J 27/211; A47J 27/62; A47J 31/18; A47J 31/5253; A47J 31/60; H05B 3/68; H05B 6/12

(57) ABSTRACT

A device for preparing a beverage, including a body; a heat source; a sensing unit comprising at least a first temperature sensor; a control system; a user interface; and a means for vertically translating the sensing unit in upwards and downwards directions. A container is used with the device for preparing the beverage, where ingredients of the beverage are added to the container prior to actuating the device to begin preparation of the beverage.

### CROSS-REFERENCE TO RELATED APPLICATIONS

This application claims the benefit of Provisional Patent Application No. 2022900337, filed Feb. 16, 2022, which is hereby incorporated by reference.

### FIELD OF THE DISCLOSURE

This disclosure relates to kitchen appliances in general, and more particularly, to kitchen appliances for preparing hot beverages.

### BACKGROUND

Preparing hot specialty beverages at home requires brewing skills, is time consuming, and needs close attention, particularly to avoid liquid, such as milk, boiling over a pot during the process of preparing a beverage. For instance, chai is prepared by boiling at least tea leaves and/or tea powder in milk, and optionally, water, herbs, spices, and sweeteners. Brewing tea and spices in milk is beneficial as the milk helps extract more flavour and colour from the tea leaves. However, the milk and/or water must go through several boiling cycles for greater, more optimal flavour extraction, requiring time and close attention to prevent the liquid from boiling over the pot. An automated device for preparing hot beverages that reduces time and attention required by a consumer in preparing a beverage is needed.

### SUMMARY

The following presents a simplified summary of some embodiments of the techniques described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Some aspects provide a device for preparing a beverage, comprising: a body; a heat source; a sensing unit comprising at least a first temperature sensor; a control system; a user interface; and a means for vertically translating the sensing unit in upwards and downwards directions; and wherein: a container is used with the device for preparing the beverage; and at least some ingredients of the beverage are placed within the container prior to actuating the device to begin preparation of the beverage.

Some aspects include a method for preparing a beverage using a device comprising: adding ingredients of the beverage within a container; vertically translating, with a mechanism of the device, a sensing unit of the device downwards from an idle position to an active position; receiving at least one input by a user interface of the device to actuate the device to begin preparation of the beverage; regulating, with the control system of the device, output of the heat source based on temperature measured by the first temperature sensor during preparation of the beverage; and vertically translating, with the mechanism of the device, the sensing unit upwards from the active position to the idle position upon completing preparation of the beverage.

### BRIEF DESCRIPTION OF THE FIGURES

FIGS. 1A-1F and FIG. 2 illustrate an example of a device for preparing a beverage including a manual mechanism for vertically translating a sensing unit, according to some embodiments.

FIG. 3 illustrates an example of a device for preparing a beverage including an autonomous mechanism for vertically translating a sensing unit, according to some embodiments.

FIG. 4 illustrates an example of a sensing unit, according to some embodiments.

FIGS. 5A and 5B illustrate an example of a device for preparing a beverage including liquid reservoirs, according to some embodiments.

FIGS. 5C and 5D illustrate an example of a container and a tea bag with a bar code, according to some embodiments.

FIGS. 5E and 5F illustrate an example of a container with a hook for suspending a tea bag, according to some embodiments.

### DETAILED DESCRIPTION OF SOME EMBODIMENTS

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

Embodiments provide a device for autonomously preparing a hot beverage, such as chai, hot chocolate, london fog, etc. The device comprises a body, a heat source for heating ingredients of the beverage, a container for holding the ingredients of the beverage, a sensing unit comprising at least a first temperature sensor, a control system, a mechanism for manually or autonomously vertically translating the sensing unit, and a user interface comprising at least a first button (physical or touch screen) for actuating the device to begin preparation of the beverage. Examples of the heat source that may be used include a plate with a resistive coil, a plate with an induction system, or other types of heat sources. In some embodiments, the device further includes a housing for storing the sensing unit when the sensing is not in use and idle. In some embodiments, the device further includes a main power switch positioned at rear of the device and vents disposed on a bottom surface of the device for dissipating heat. In some embodiments, the device further includes a fan for heat dissipation.

In one embodiment, ingredients of a beverage are placed within the container. For example, for a chai beverage, ingredients including at least some of milk, water, tea leaves, powder, herbs/spices, and sweeteners, are placed within the container. The sensing unit is manually or autonomously vertically translated downwards until a sensor tip of the first temperature sensor is at a particular distance above a top surface of the mixture of ingredients within the container. In the preferred embodiment, the distance of the sensor tip to the top surface of the mixture is one to five centimeters. In the case of automated vertical translation of the sensing unit, activating the first button causes the mechanism to autonomously translate the sensing unit vertically downwards from an idle position, wherein the sensing unit is stored in the housing, to an active position, wherein the sensing unit is in the active position such that the sensor tip of the first temperature sensor is at a particular distance, preferably one to five centimeters, from the top surface of the ingredients within the container. Activating the first button also causes the heat source to provide an output to heat the ingredients within the container. In the case of manual vertical translation of the sensing unit, the sensing unit is manually translated vertically downwards from the idle position to the active position prior to activating the first button to begin preparation of the beverage. In some embodiments, other means may be used to actuate the device to begin preparation of the beverage. For example, a sensor disposed on the device may detect a signal received from a smart device, the signal actuating the device to begin preparation of the beverage. Other methods for communicating instructions to the device are further described below.

In some embodiments, the first temperature sensor is coupled to the heat source system via the control system. During preparation of the beverage, the first temperature sensor provides real-time feedback to the control system and the control system regulates output of the heat source based on the temperature measured by the first temperature sensor. In some embodiments, the control system regulates the output of the heat source by switching the heat source on and off or by controlling an amount of current provided to the heat source.

For milk-based beverages in particular, the top surface of the mixture of ingredients rises as the mixture is heated to a boil. As the top surface of the mixture of ingredients rises the mixture may contact or come into close contact with the sensor tip of the first temperature sensor. As such, a sudden increase in temperature is sensed by the first temperature sensor and is fed to the control system. The control system regulates the output of the heat source based on the temperature sensed by the first temperature sensor. In some embodiments, the control system turns off the heat source upon detecting a rise in temperature rate by at least 0.4 degree Celsius per second (or different temperature rate threshold in other embodiments) to reduce the heat provided to the mixture of ingredients. The temperature rate threshold may be the same or different for different boiling cycles. In some embodiments, the control system reduces an amount of current provided to the heat source to reduce the heat provided to the mixture of ingredients. As a result, the mixture of ingredients cools causing the top surface of the mixture to lower once again. As such, a sudden decrease in temperature is sensed by the first temperature sensor and is fed to the control system. The control system regulates the output of the heat source, either initiating an additional boiling cycle or ceasing the process. In some embodiments, the control system initiates the additional boiling cycle upon detecting a decrease in temperature rate by at least 0.4 degree Celsius per second (or different temperature rate threshold in other embodiments) by turning on the heat source or increasing the amount of current provided to the heat source. The temperature rate threshold may be the same or different for different boiling cycles. In some embodiments, the control system initiates the additional boiling cycle after a time delay from when the sudden increase in temperature was detected or from when the control system turns off or reduces the amount of current provided to the heat source. Reducing the amount of current provided to the heat source to a simmer during this time delay may help in optimizing brewing, extracting flavours to a greater extent. In some embodiments, the control system determines when to initiate the additional boiling based on detecting the sudden decrease in temperature and the time delay. In some embodiments, the control system initiates an additional boiling cycle using a same or a different time delay for different boiling cycles. The control system ceases the process based on the number of boiling cycles. In some embodiments, the user interface further comprises a second button (physical or touch screen) for choosing a strength of the beverage. In some embodiments, the number of boiling cycles is determined based on the strength of the beverage chosen. In some embodiments, the second button is activated one, twice, or three times in a row for a low, medium, or high strength, respectively, wherein the low, medium, and high strengths correspond with one, two, and three boiling cycles, respectively. The strength of the beverage is selected using the second button prior to activating the first button. In some embodiments, the device generates a sound upon completion of the process. The sensing unit is manually or autonomously returned to the idle position after completion of the process. Upon completion of the beverage preparation process, the beverage is poured from the container into one or more cups for consumption.

In some embodiments, capsules for housing tea leaves, powder (e.g., black tea powder, hot chocolate powder), herbs/spices (e.g., cardamom, ginger, etc.), and/or sweetener (e.g., sugar, honey, jaggery, etc.) are placed within the container along with water and/or milk prior to beginning preparation of the beverage. In some embodiments, tea leaves, powder, herbs/spices, and/or sweetener, etc. are loosely suspended in the water and/or milk within the container prior to beginning preparation of the beverage. In some embodiments, tea leaves, powder, herbs/spices, and/or sweetener, etc. are encapsulated in permeable/semi-permeable sacs (e.g., tea bags) and the sacs are loosely suspended in the water and/or milk within the container prior to beginning preparation of the beverage. In some embodiments, the capsules or the permeable/semi-permeable sacs or other equivalent casings for ingredients are specially fabricated for use with the device. In some embodiments, one of or particular combinations of tea leaves, powder, herbs/spices, and/or sweetener, etc. are housed in a single capsule or permeable/semi-permeable sac and one or more capsule or permeable/semi-permeable sac are used in preparing the beverage (depending on the preferences of a consumer).

In some embodiments, the sensing unit further comprises at least one heat sink. In some embodiments, the at least one heat sink is cylindrical. However, the shape of the at least one heat sink may vary. In some embodiments, the at least one heat sink is positioned such that a heat sink tip of the at least one heat sink is levelled with the sensor tip of the first temperature sensor. In other embodiments, the heat sink tip is positioned such that it is vertically lower or higher than the sensor tip of the first temperature sensor. The position of the heat sink tip relative to the sensor tip of the first temperature sensor depends on a strength of the heat sink. The stronger the heat sink, the further higher the heat sink tip can be relative to the sensor tip of the first temperature sensor. The at least one heat sink enables the prevention of overflow of the mixture of ingredients as the mixture rises within the container. The at least one heat sink may act as a fail-safe in cases where the first temperature sensor malfunctions and prevents the control system from properly regulating the output of the heat source. In some embodiments, the at least one heat sink is fabricated from food-grade stainless steel. Other materials may also be used to fabricate the at least one heat sink. In some embodiments, the heat sink may be in a form of a rim (full or partial) of the container.

In some embodiments, the at least one heat sink is coupled with a heat sink temperature sensor. In case of malfunction or failure of the first temperature sensor, the first temperature sensor fails to measure a rise in temperature, and therefore, output the rise in temperature to the control system. The heat source therefore continues providing heat output. In such a scenario, the heat sink continues to dissipate the excessive heat and the control system detects, based on output from the heat sink temperature sensor, an unexpected continued high heat sink temperature when a drop in the heat sink temperature is expected. This is indicative of failure of the first temperature sensor, and as a result, the control system may turn off the heat source. In some embodiments, wherein the heat source comprises a plate with an induction system, the at least one heat sink may not be as necessary. With induction, the output of the heat source is reduced or turned off much faster than with a resistive hot plate. As such, the at least one heat sink is more useful when the heat source comprises the resistive hot plate to enable dissipation of excess heat while the resistive hot plate continues to cool down.

In some embodiments, the mechanism for manually vertically translating the sensing unit comprises at least a rotary knob, a rotational bearing, a lead screw, a linear bearing, and a connecting plate to which the sensing unit is attached. The lead screw is fixed to the knob such that rotation of the knob causes rotation of the lead screw, while the rotational bearing is in place to smoothen rotation of the lead screw. The connecting plate, to which the sensing unit is attached, is translationally coupled to the lead screw while the linear bearing is in place to smoothen linear translation of the connecting plate and attached sensing unit. Rotation of the knob in a first direction causes the lead screw to rotate in the first direction and the connecting plate and attached sensing unit to vertically translate upwards. Rotation of the knob in the second direction causes the lead screw to rotate in the second direction and the connecting plate and attached sensing unit to vertically translate downwards. The mechanism for manually vertically translating the sensing unit is used to lower the sensing unit from the idle position (i.e., the housing) to the active position (i.e., one to five centimeters from the top surface of the mixture of ingredients) prior to activating the first button to actuate preparation of the beverage. The manual mechanism is used to also return the sensing unit to the idle position (i.e., the housing) after preparation of the beverage is complete. Other mechanisms for manually vertically translating the sensing unit may be used to achieve vertical translation of the sensing unit. For example, a rotary knob and a rack and pinion mechanism may be used for vertical translation of the sensing unit. Alternatively, a vertical slide along a vertical linear bearing and a screw mechanism to tighten the sensing unit to the desired positioned may be used for vertical translation of the sensing unit.

In some embodiments, the mechanism for autonomously vertically translating the sensing unit comprises at least a distance sensor (e.g., an ultrasonic sensor, a LIDAR sensor, IR transmitter/receiver, etc.), a lead screw, a linear bearing, a motor to rotationally drive the lead screw, a limit switch, and a connecting plate to which the sensing unit is attached. The connecting plate, to which the sensing unit is attached, is translationally coupled to the lead screw while the linear bearing is in place to smoothen linear translation of the connecting plate and attached sensing unit. Rotation of the lead screw in the first direction causes the connecting plate and attached sensing unit to vertically translate upwards and rotation of the lead screw in the second direction causes the connecting plate and attached sensing unit to vertically translate downwards. The limit switch provides an indication that the connecting plate and sensing unit have reached an upper vertical limit, or otherwise, the idle position. Upon activating the first button, the motor lowers the sensing unit from the housing of the device until the distance sensor measures a particular distance to the top surface of the mixture of ingredients. Upon reaching the particular distance, the sensor tip of the first temperature sensor is within a desired distance range (e.g., one to five centimeters) from the top surface of the mixture of ingredients. In another embodiment, the mechanism for autonomously vertically translating the sensing unit comprises at least a weight sensor for measuring a weight of the ingredients placed within the container, the lead screw, the linear bearing, the motor to rotationally drive the lead screw, the limit switch, and the connecting plate to which the sensing unit is attached. Given a volume of the container is known, the motor lowers the sensing unit from the housing of the device a particular distance based on the weight measured. Upon reaching a particular distance, the sensor tip of the first temperature sensor is within the desired distance range from the top surface of the mixture of ingredients. In one embodiment, the mechanism for autonomously vertically translating the sensing unit comprises at least a means for providing an input (e.g., a number of cups to prepare) to the device (e.g., via a third button of the user interface), the lead screw, the linear bearing, the motor to rotationally drive the lead screw, the limit switch, and the connecting plate to which the sensing unit is attached. Given the volume of the container is known, the motor lowers the sensing unit from the housing of the device a particular distance based on the input provided. Upon reaching the particular distance, the sensor tip of the first temperature sensor is within a desired distance range from the top surface of the mixture of ingredients. In some embodiments, multiple manual and/or autonomous mechanisms for vertically translating the sensing unit are implemented into the device such that malfunction of one mechanism does not impede functionality of the device and accuracy of one mechanism may be cross-checked with another mechanism. For example, the particular distance by which the sensing unit is to be lowered as determined based on a first autonomous mechanism may be confirmed and cross-checked with the particular distance by which the sensing unit is to be lowered as determined based on a second autonomous mechanism. In some embodiments, the device provides a notification (e.g., via the user interface of the device or an application of a smart device) when there is inconsistency or discrepancy between the autonomous and/or manual mechanisms. Other manual and autonomous mechanisms for vertically translating the sensing unit than those described herein may be used.

In some embodiments, a first side of a plate of the sensing unit is attached to the connecting plate using magnets. The first temperature sensor and the at least one heat sink (when applicable) are attached to a second side of the plate of the sensing unit. Upon attaching the sensing unit to the connecting plate, leads of the first temperature sensor get electrically connected with the control system via the connecting plate. Other means for attaching the sensing unit to the connecting plate may be used, such as a spring-loaded latch mechanism, a snap fit mechanism, a dove tail slot/keyway mechanism, and threads (e.g., wherein the sensing unit is screwed on to or off from the connecting plate). In one example, the sensing unit is automatically rotated and screwed into place upon the sensing unit being aligned with the connecting plate for attachment. The sensing unit may also be automatically rotated to detach the sensing unit from the connecting plate. In some embodiments, the device enters a cleaning mode for cleaning the sensing unit, wherein the mechanism autonomously vertically translates the sensing unit downwards to a lowest position such that the sensing unit may be wiped or detached from the connecting plate by pulling, turning, twisting or by other means depending on the attachment means, to be rinsed/washed in a sink or dishwasher. In some embodiments, the device enters the cleaning mode with a long press of the first or second button or upon activating another button disposed on the device. In some embodiments, the sensing unit is vertically translated to the lowest position manually using the manual mechanism.

In some embodiments, the user interface further comprises an input means for selecting a particular temperature or a warming function (e.g., a button of the user interface or a dial or buttons for adjusting a displayed temperature) and a second temperature sensor coupled with the heat source and the control system. The control system regulates the output of the heat source based on temperature measured by the second temperature sensor such that the particular temperature or a temperature corresponding with the warming function is maintained. This allows the contents of the container to remain warm for delayed consumption of the beverage. In some embodiments, the control system regulates the output of the heat source based on temperature measured by the first temperature sensor such that the particular temperature or a temperature corresponding with the warming function is maintained. In some embodiments, the control system regulates the output of the heat source based on temperature measured by the first temperature sensor and the second temperature sensor such that the particular temperature or a temperature corresponding with the warming function is maintained.

In some embodiments, the device further includes at least one reservoir. The at least one reservoir may include a first reservoir for milk and a second reservoir for water. In some embodiments, the user interface further includes input means for selecting a number of cups to brew, a proportion of milk and water to use in preparing a beverage, a type of beverage to prepare, a beverage strength, a number of boiling-cooling cycles, and/or particular ingredients to use in preparing the beverage (e.g., particular tea leaves, powder, sweeteners, etc.). The device autonomously dispenses the appropriate amounts of milk and/or water within the container prior to preparing the beverage based on any of the number of cups to brew, the proportion of milk and water to use in preparing the beverage, the time, a dispensing sequence of the milk and water and/or the type of beverage to prepare. In some embodiments, an electronic pump is used to dispense the milk or water from their respective reservoir into the container. Other means may also be used to transfer milk or water from their respective reservoir to the container. In some embodiments, the device further includes a cooling pad or a cooling system for maintaining a particular temperature of the contents within the reservoir (e.g., 4 degrees Celsius or less). In some embodiments, the user interface further comprises an input means for selecting a particular temperature.

In some embodiments, the device includes a mechanism for autonomously placing, dropping, or suspending capsules or permeable/semi-permeable sacs of ingredients within the container based on any of the number of cups to brew, the proportion of milk and water to use in preparing the beverage, the beverage strength, the number of boiling-cooling cycles, the type of beverage to prepare, and/or the ingredients selected. In some embodiments, permeable/semi-permeable sacs (e.g., tea bags) comprise a bar code or QR code, such as on an end of a string attached to the sac. An imaging sensor disposed on the device captures and processes the code. By processing the code, the device extracts at least one of a type of beverage being brewed, a beverage strength, a proportion and dispensing sequence of milk and water, a proportion of time for which the beverage is brewed in water and brewed in milk, and an amount of time to simmer the beverage after the boiling cycles are complete. In some embodiments, custom tea bags with bar codes/QR codes for use with the device are supplied to the consumer to enable the consumer to prepare customised beverages and save time used in repeatedly providing parameter inputs to the device.

In some embodiments, the user interface further includes input means for selecting at least one of a number of boiling-cooling cycles, a number of cups to brew, a strength of a beverage, a particular time and/or day to autonomously begin preparing the beverage (e.g., 5 AM every day or 8 AM on Mondays and Fridays), a type of the beverage (e.g., chai, london fog, hot chocolate, milk, etc.), a proportion of milk and water to use in preparing the beverage, a proportion of time for which the beverage is brewed in water and brewed in milk, an amount of time to simmer the beverage after the boiling cycles are complete, an instruction to warm the beverage, and an instruction to start, pause, or stop the process of preparing the beverage. In some embodiments, the user interface is used to program and store a custom program for preparing a beverage. The input means may include physical buttons and/or touchscreen buttons. In some embodiments, the touchscreen displays a status of the device (e.g., off, on, pause, idle, preparing beverage, brewing complete, warming, etc.), a notification (e.g., temperature sensor malfunction, weight sensor malfunction, etc.), a progress of the process (e.g., displayed as a progress bar), temperature measured by the first temperature sensor, weight measured by the weight sensor, the number of boiling-cooling cycles, the number of cups to brew, the strength of the beverage, the particular time and/or day to autonomously begin preparing the beverage, the type of the beverage, the proportion of milk and water to use in preparing the beverage, the proportion of time for which the beverage is brewed in water and brewed in milk, the amount of time to simmer the beverage after the boiling cycles are complete.

In some embodiments, the device is wirelessly connected with an application executed on a smart device configured to display information related to the device and receive user input. In some embodiments, the application receives user input designating at least one of a number of boiling-cooling cycles, a number of cups to brew, a strength of a beverage, a particular time and/or day to autonomously begin preparing the beverage (e.g., 5 AM every day or 8 AM on Mondays and Fridays), a type of the beverage (e.g., chai, london fog, hot chocolate, milk, etc.), a proportion of milk and water to use in preparing the beverage, a proportion of time for which the beverage is brewed in water and brewed in milk, an amount of time to simmer the beverage after the boiling cycles are complete, an instruction to warm the beverage, and an instruction to start, pause, or stop the process of preparing the beverage. In some embodiments, the application is used to program and store a custom program for preparing a beverage. In some embodiments, the application displays a status of the device (e.g., off, on, pause, idle, preparing beverage, brewing complete, etc.), a notification (e.g., temperature sensor malfunction, weight sensor malfunction, etc.), a progress of the process (e.g., displayed as a progress bar), temperature measured by the first temperature sensor, weight measured by the weight sensor, the number of boiling-cooling cycles, the number of cups to brew, the strength of the beverage, the particular time and/or day to autonomously begin preparing the beverage, the type of the beverage, the proportion of milk and water to use in preparing the beverage, the proportion of time for which the beverage is brewed in water and brewed in milk, the amount of time to simmer the beverage after the boiling cycles are complete.

In some embodiments, the device is wirelessly connected with a voice assistant (e.g., Alexa, Google home, etc.). In some embodiments, instructions are provided to the device by providing voice commands to the voice assistant. For example, the voice command “Hey Google, brew two cups of chai” is received by a Google home assistant and the instruction is wirelessly transmitted to the device, causing the device to autonomously begin preparing two cups of chai. In another example, the voice command “Alexa, brew one cup of london fog tomorrow morning at 7 AM” is received by an Alexa voice assistant and the instruction is wirelessly transmitted to the device, causing the device to autonomously begin preparing one cup of london fog the next morning at 7 AM. In some embodiments, the device is voice activated and the voice commands are provided directly to the device.

In some embodiments, the device further includes a protective covering encasing at least the sensor tip of the first temperature sensor to prevent any suspended matter within the mixture of ingredients from causing an obstruction or a malfunction of the first temperature sensor. The protective covering may be fabricated of a mesh. In some embodiments, the protective covering is detachable for washing.

In some embodiments, the container includes a hook for hanging at least one permeable/semi-permeable sac (e.g., tea bag, masala bag, etc.) in place or for limiting movement of the sac within the container. In some embodiments, other accessories may be included with the device, such as a stirrer, a mesh strainer for housing some ingredients of the beverage (e.g., tea leaves, coffee powder), a milk frother, etc. In some embodiments, the heat source is integrated with a magnetic stirring mechanism. A magnetic stirring bar (or magnetic disc or other magnetic object type) is placed within the container along with the ingredients and the magnetic stirring mechanism drives movement of the magnetic stirring bar, causing the ingredients within the container to be stirred. In some embodiments, the user interface includes input means for controlling an intensity of the stirring and/or for activating or deactivating the stirring feature.

The device may be used to prepare various types of beverages (e.g., chai, london fog, hot chocolate, saffron milk, turmeric milk or latte, vanilla milk, southern Indian filter coffee, etc.) or for warming a beverage (e.g., milk). In some embodiments, the device is used in preparing at least of a portion of a particular type of food.

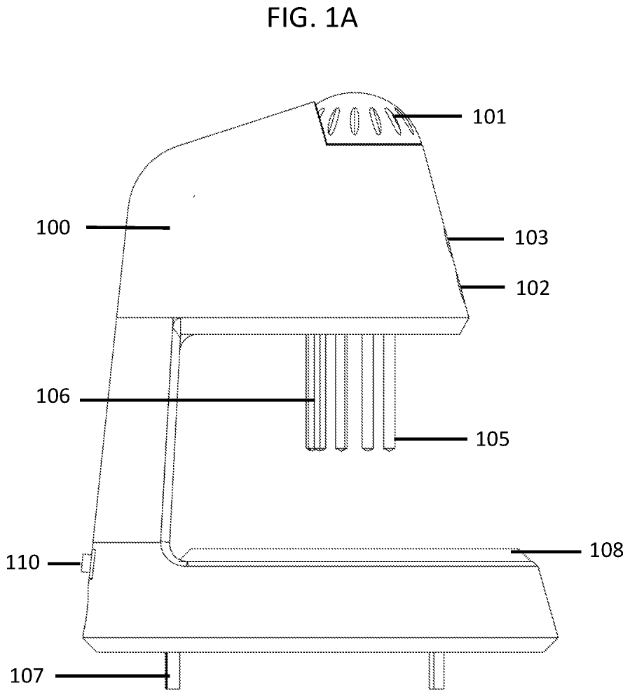

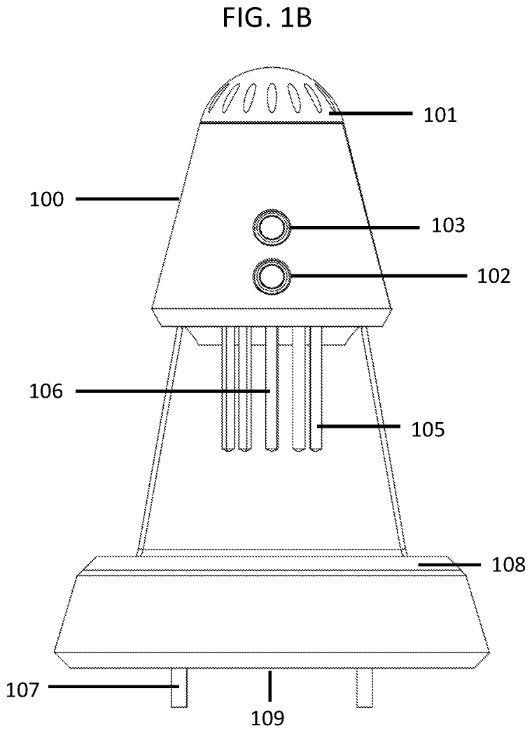

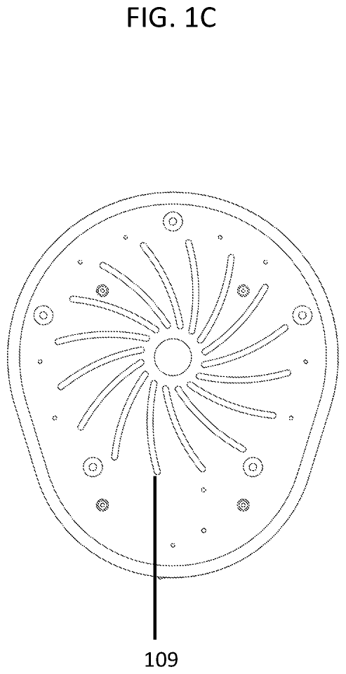

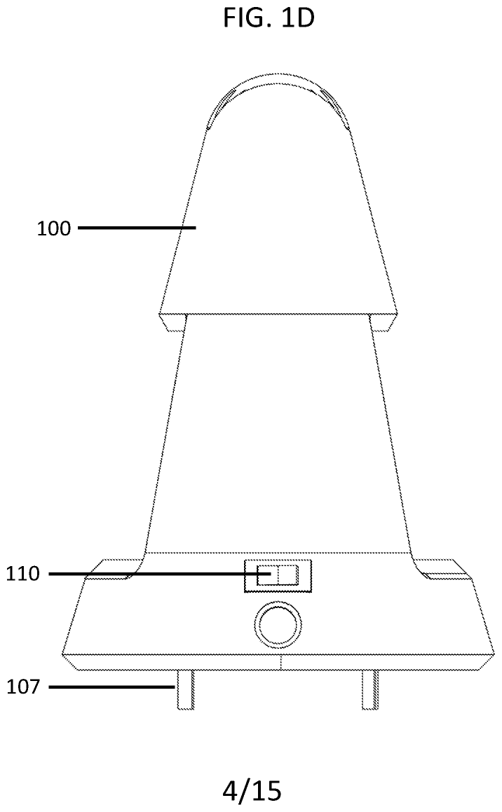

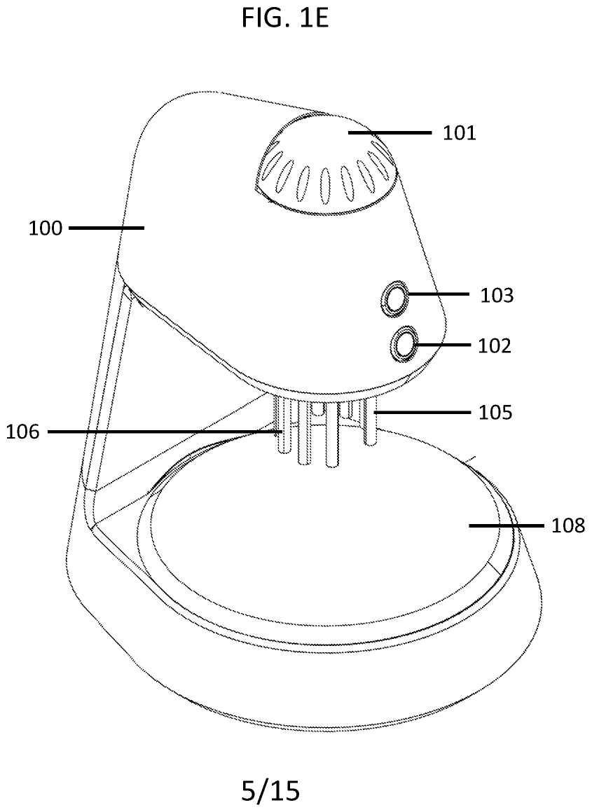

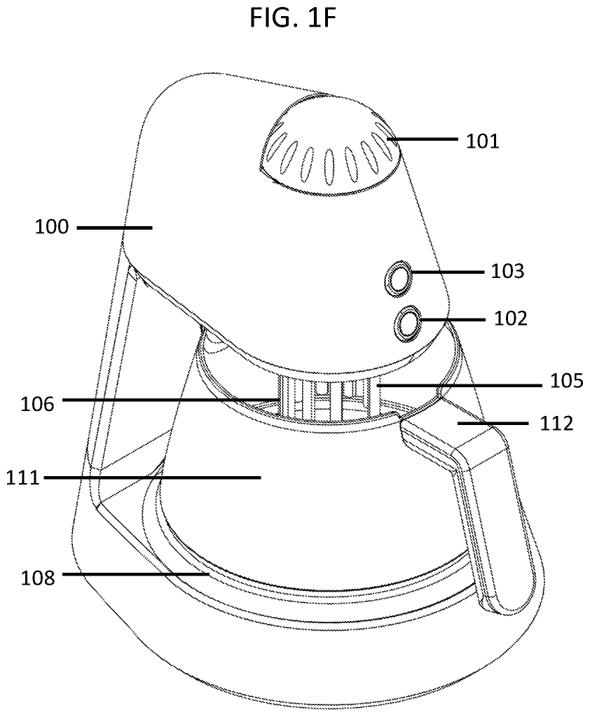

FIGS. 1A-1F illustrate an example of a device for creating a hot beverage. The device includes a body 100, a knob 101, a first button 102, a second button 103, a sensing unit including temperature sensor 105 and heat sinks 106, base legs 107, a heat source including heating surface 108, air vents 109, a main power switch 110, a container 111, and a handle 112 of container 111. Pressing the first button 101 actuates preparation of the beverage. The second button 103 is pressed once, twice, or three times to select a low, medium, or strong beverage strength prior to actuating preparation of the beverage. Ingredients for the beverage are placed and held in the container 111 and heated by the heat source through use of electrical current. The knob 101 is used for manually translating the sensing unit with temperature sensor 105 and heat sinks 106 upwards and downwards between the idle position and the active position, as is described in detail above. The sensing unit is lowered to the active position prior to actuating preparation of the beverage. The temperature sensor 105 measures the temperature of the beverage and feeds the temperature back to a control system regulating output of the heat source during preparation of the beverage, as described in detail above. The heat sinks 106 dissipate excess heat from the beverage to prevent boil over in the container 111. The air vents 109 located on a bottom surface of the body 100 allow heat to escape from within the body 100.

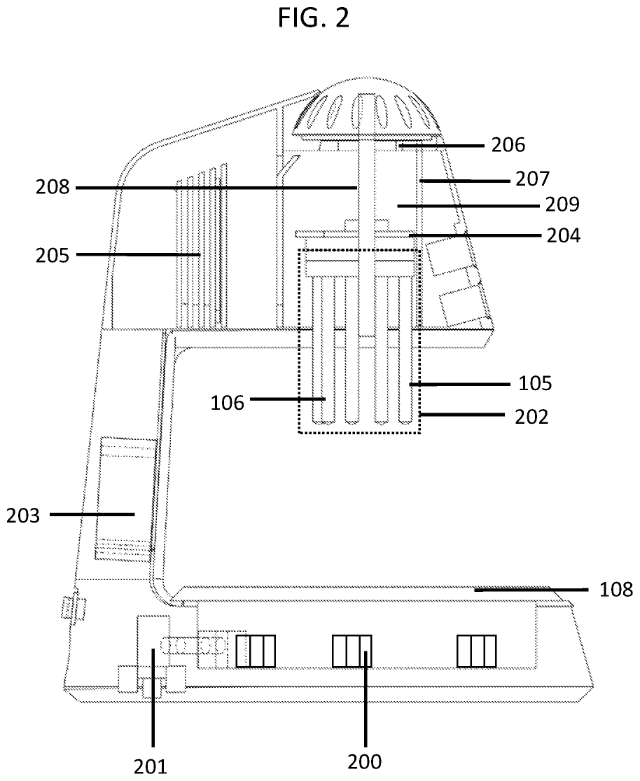

FIG. 2 illustrates internal components of the device illustrated in FIGS. 1A-1F, including a heating surface 108 of a heat source 200, a thermostat 201, a sensing unit 202 including temperature sensor 105 and heat sinks 106, a relay 203, a connecting plate 204, a control system 205, a rotational bearing 206, a linear bearing 207, a lead screw 208, and a housing 209 of the sensing unit 202. The heat source 108 uses electric current to create heat in the heating surface 200 through either a resistive coil or by creating magnetic fields in an electromagnet. The sensing unit 202 attaches to the connecting plate 204 using paired magnets with opposing polarities to ensure the two components align. The temperature sensor 105 connects electrically to the control system 205 upon attaching the sensing unit 202 with the connecting plate 204 given that the connecting place 204 is electrically connected to the control system 205. As described in detail above, the control system 205 uses feedback from the temperature sensor 105 in the beverage to open and close the relay 203, allowing or preventing the flow of electrical current to the heat source 200 during preparation of the beverage. Thermostat 201 controls a level of heat generated by the heat source 200. The control system 205 controls the thermostat 201 and the relay 203 to turn the heat source 200 on and off and/or regulate the level of output of the heat source 200. Operation of the manual mechanism for raising and lowering the sensing unit 105, comprising of the knob 101, the connecting plate 204, the rotational bearing 206, the linear bearing 207, and the lead screw 208, is described in detail above.

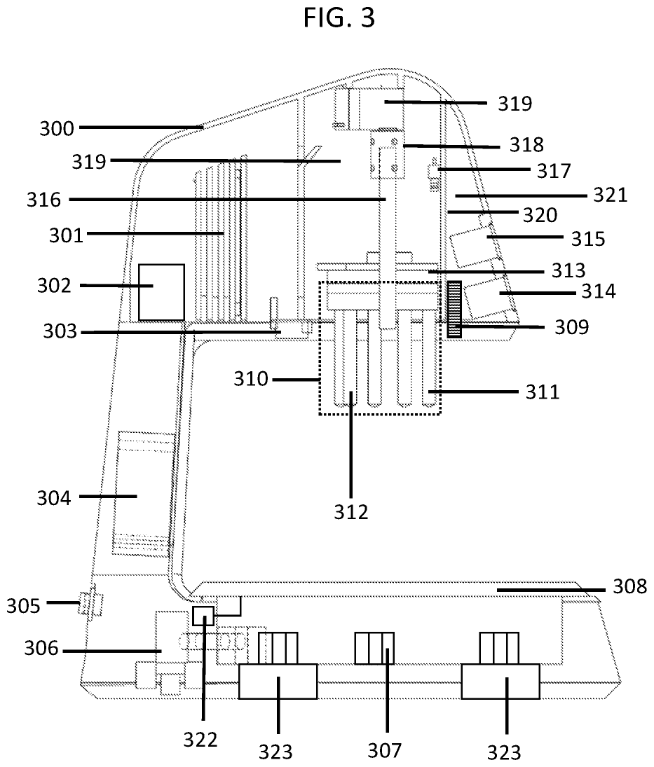

FIG. 3 illustrates another example of the device, wherein the mechanism for vertically translating the sensing unit upwards and downwards between the idle position and the active position is autonomous. FIG. 3 illustrates a body 300, a control system 301, an audio module including a speaker and/or a microphone 302, a distance sensor 303, a relay 304, a power switch 305, a thermostat 306, a heat source 307, a heating surface 308 of the heat source 307, an image sensor 309, a sensing unit 310 including a first temperature sensor 311 and heat sinks 312, a connecting plate 313, a first button 314, a second button 315, a lead screw 316, a limit switch 317, a coupler 318, a drive motor 319, a linear bearing 320, a housing 321 of the sensing unit 310, a second temperature sensor 322, and a weight sensor 323. The drive motor 319 is rotationally coupled to the lead screw 316 using the coupler 318. The relay 304, power switch 305, heat source 307, first button 314, and second button 315 operate in a similar manner as in FIGS. 1A-1F. The control system 301 comprises a printed circuit board with integrated circuit microcontroller, a wireless communication module, and other electronic components. The control system 301 receives feedback from the first temperature sensor 311 and regulates output of the heat source 307, as described in detail above. The second temperature sensor 322 is coupled with the heat source 307 and the control system 301. The control system 301 regulates the output of the heat source 307 based on temperature measured by at least one of the first temperature sensor 311 and the second temperature sensor 322 such that a particular selected temperature or a temperature corresponding with a warming function is maintained. This allows contents of a container disposed on the heating surface 308 to remain warm for delayed consumption of the contents.

In this case, the control system 301 also receives feedback from the distance sensor 303 to automatically control vertical translation of the sensing unit 310 from the idle position to the active position. Operation of the autonomous mechanism for translating the sensing unit 310, comprising the connecting plate 313, the lead screw 316, the limit switch 317, the drive motor 319, and the linear bearing 320, based on sensor readings of the distance sensor 303 is described in detail above. The weight sensor 323 measures a weight of the contents within a container disposed on the heating surface 308. The control system 301 determines a particular distance by which to vertically translate the sensing unit 310 downwards to reach the active position based on weight sensor measurements and a known volume of the container. In some embodiments, the control system 301 uses the particular distance, as determined based on weight sensor measurements, to cross-check a distance by which the sensing unit 310 is vertically translated downwards into the active position, as determined based on distance sensor measurements. In some embodiments, the particular distance by which to vertically translate the sensing unit 310 downwards to reach the active position is determined solely based on weight sensor measurements or based on both weight sensor measurements and distance sensor measurements.

The image sensor 309 scans a bar code or QR code of a tea bag placed within or prior to being placed within the container. Information extracted from the bar code or QR code is communicated to the control system 301. The control system uses the information to identify a particular beverage corresponding with the tea bag and actuates a particular program for preparing the beverage. A speaker and/or microphone 302 module is a further embodiment which can be used for alerting the user that the beverage is ready or can accept spoken commands from the user to for example start the beverage brewing process.

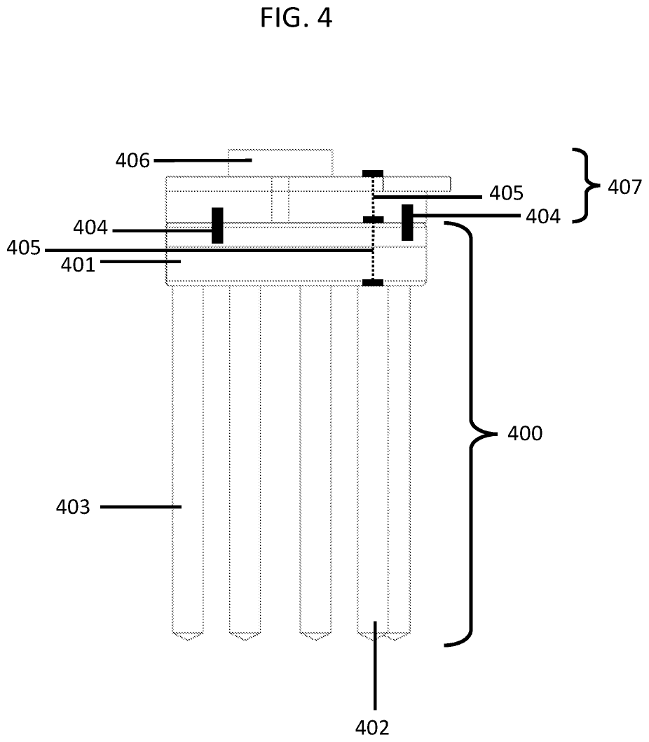

FIG. 4 illustrates an example of a sensing unit 400 of the device including a plate 401, a temperature sensor 402, heat sinks 403, magnets 404, and connection leads 405. The sensing unit 400 is detachable from the device to allow for cleaning and attaches to the device via plate 401. Plate 401 is removably attached to a connecting plate 407 of the manual or autonomous mechanism for translating the sensing unit (as in FIGS. 2 and 3) using the lead screw nut 406. The attachment is made through a plurality of paired magnets 404 on the plate 401 of the sensing unit 400 and the connecting plate 407 of the manual or autonomous mechanism for translating the sensing unit. The arrangement and polarity of the plurality of paired magnets 404 ensures the sensing unit 400 can only connect with the connecting plate 407 in a single orientation. When the sensing unit 400 and the connecting plate 407 are attached, the connection leads 405 of the temperature sensor 402 come in contact to close a communication circuit to a control system, as described in detail above.

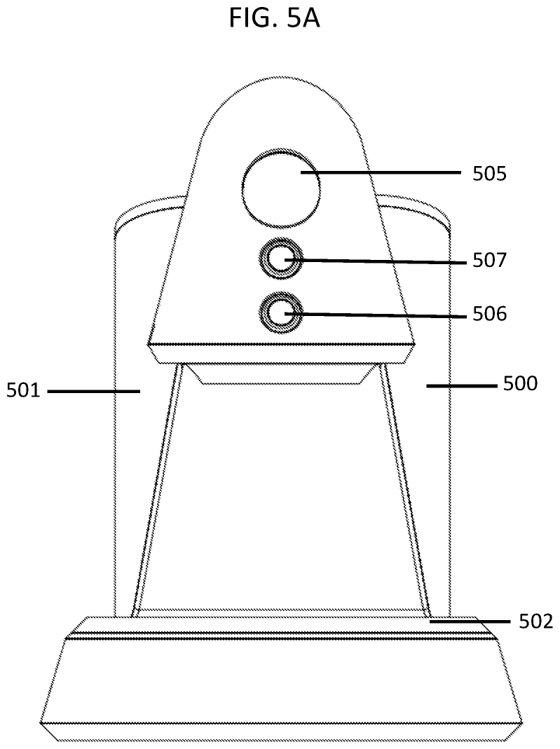

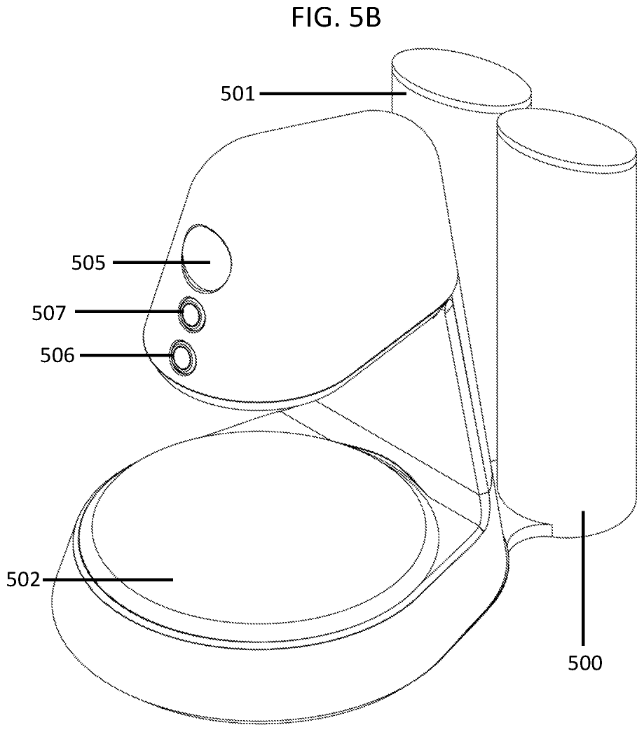

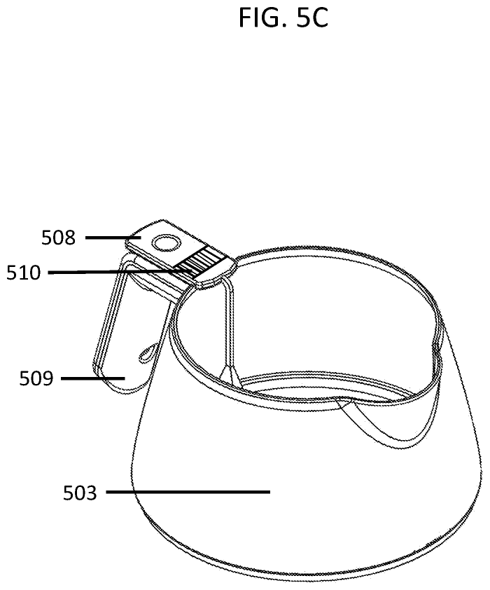

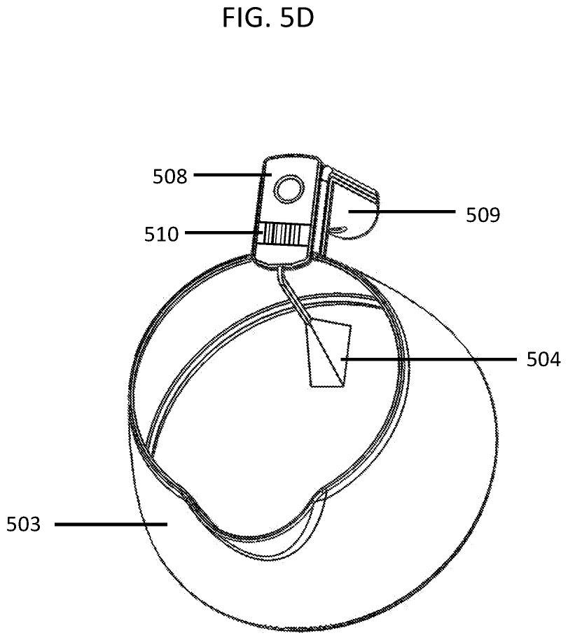

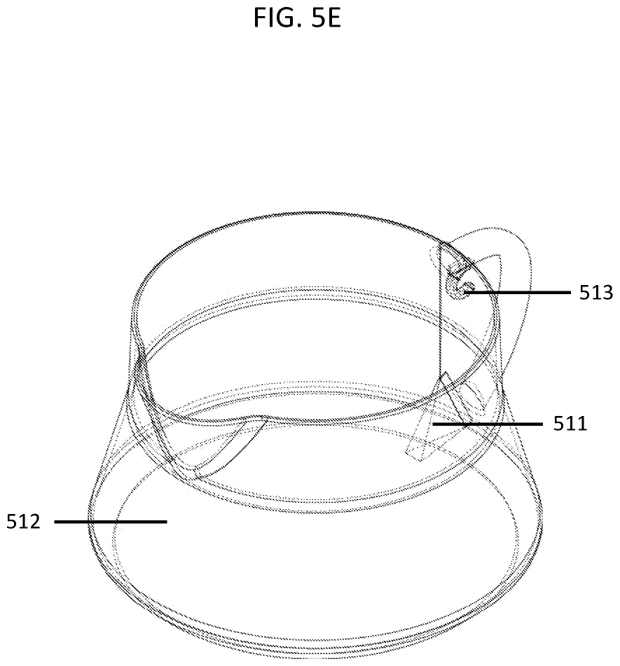

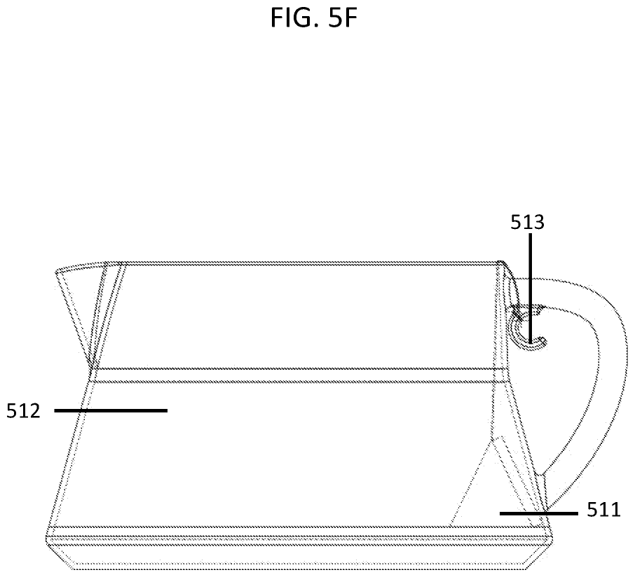

FIGS. 5A-5F illustrate another example of the device including a first reservoir 500 for milk, a second reservoir 501 for water, a heating surface 502, a container 503 within which a tea bag 504 is suspended, a digital user interface 505, a first button 506, and a second button 507. The first button 506 and the second button 507 operate in a similar manner as in FIGS. 1A-1F. The user interface may display various types of information, as is described in detail above. FIGS. 5C and 5D illustrate the tea bag 504 suspended within the container 503 using a clamp 508 attached to a handle 509 of the container 503. The clamp 508 may facilitate ease of reading of a bar code 510 on the tea bag 504 by an image sensor, as detailed above. The clamp 508 may optionally be of different shapes, such as the shape of a hook to facilitate ease of suspension and removal of the tea bag 504 from the container 503. For example, FIGS. 5E and 5F illustrate a tea bag 511 suspended within a container 512 by attaching a string of the tea bag 511 to a hook 513. The reservoirs for milk 500 and water 501 provide further autonomy to the device, wherein the device autonomously dispenses the required or requested ratio of milk and water to the container 503 without user intervention, as is further described in detail above. A cooling pad may be positioned below the milk reservoir 500 to keep the milk cool and fresh.

1. A device for preparing a beverage, comprising:
a body;
a heat source;
a sensing unit comprising at least a first temperature sensor;
a control system;
a user interface; and
a means for vertically translating the sensing unit in upwards and downwards directions; and
wherein:
a container is used with the device for preparing the beverage; and
at least some ingredients of the beverage are placed within the container prior to actuating the device to begin preparation of the beverage.

2. The device of claim 1, wherein:
the device is a component of an apparatus; and
the apparatus further comprises the container.

3. The device of claim 1, wherein the means for vertically translating the sensing unit translates the sensing unit between at least an idle position and an active position.

4. The device of claim 3, wherein the sensing unit is in the idle position when the sensing unit is stored within a housing of the body.

5. The device of claim 3, wherein the sensing unit is in the active position when a sensing tip of the first temperature sensor is within a particular range of distance from a top surface of the ingredients within the container.

6. The device of claim 5, wherein the particular range of distance comprises a range of one to five centimeters.

7. The device of claim 1, wherein the user interface receives at least one input towards actuating the device to begin the preparation of the beverage.

8. The device of claim 1, wherein the preparation of the beverage comprises at least the control system regulating the heat source based on temperature rate measured by the first temperature sensor.

9. The device of claim 8, wherein:
the control system regulates the heat source upon measuring an increase or decrease in temperature rate by the first temperature sensor by at least 0.4 degree Celsius per second.

10. The device of claim 1, wherein the sensing unit further comprises at least one heat sink, wherein the at least one heat sink dissipates heat during the preparation of the beverage to prevent at least a portion of ingredients within the container from boiling over the container.

11. The device of claim 1, wherein:
the means for vertically translating the sensing unit in the upwards and downwards directions comprises a manual mechanism;
the manual mechanism comprises:
a knob rotationally coupled to the body of the device;
a translating mechanism driven by the knob; and
a connecting plate translationally coupled to the translating mechanism; wherein:
the sensing unit is removably connected to the connecting plate;
manual rotation of the knob in a first direction causes the connecting plate, and the sensing unit connected thereto, to vertically translate upwards; and
manual rotation of the knob in a second direction causes the connecting plate, and the sensing unit connected thereto, to vertically translate downwards.

12. The device of claim 1, wherein:
the means for vertically translating the sensing unit in the upwards and downwards directions comprises an autonomous mechanism;
the autonomous mechanism comprises:
a distance sensor;
a motor;
a translating mechanism driven by the motor; and
a connecting plate translationally coupled to the translating mechanism; wherein:
the sensing unit is removably connected to the connecting plate;
rotation of the translating mechanism by the motor in the first direction causes the connecting plate, and the sensing unit connected thereto, to vertically translate upwards;
rotation of the translating mechanism by the motor in the second direction causes the connecting plate, and the sensing unit connected thereto, to vertically translate downwards; and
the distance sensor measures a distance at least to a top surface of the ingredients within the container.

13. The device of claim 1, wherein the device further comprises at least a first reservoir and a second reservoir for storing a first liquid and a second liquid, respectively.

14. The device of claim 1, wherein:
the user interface comprises at least a first button and a second button;
the first button is pressed once or consecutively twice or three times to select a low, medium, or high beverage strength, respectively;
the second button is pressed to actuate the device to begin the preparation of the beverage after selecting the beverage strength; and
the beverage strength determines a number of boiling cycles required for preparation of the beverage, wherein low, medium, and high beverage strengths correspond to one, two, and three boiling cycles, respectively.

15. The device of claim 1, wherein:
the sensing unit is attached to at least one component of the means for vertically translating the sensing unit using at least one pair of magnets; and
the sensing unit is detachable from the at least one component.

16. The device of claim 1, wherein the heat source comprises a heating surface with a resistive coil or a heating surface with an induction system.

17. The device of claim 1, wherein:
the control system maintains a particular warming temperature by regulating the output of the heat source based on temperatures measured by at least one of the first temperature sensor and a second temperature sensor of the device.

18. The device of claim 1, wherein at least one of:
the device further comprises an audio module for receiving audio inputs and generating audio outputs;
the container further comprises a clamp or a hook for suspending a permeable or semi-permeable sac; and
the device further comprises a protective covering for covering the first temperature sensor.

19. A method for preparing a beverage using a device comprising:
adding ingredients of the beverage within a container;
vertically translating, with a mechanism of the device, a sensing unit of the device downwards from an idle position to an active position;
receiving at least one input by a user interface of the device to actuate the device to begin preparation of the beverage;
regulating, with the control system of the device, output of the heat source based on temperature measured by the first temperature sensor during preparation of the beverage; and
vertically translating, with the mechanism of the device, the sensing unit upwards from the active position to the idle position upon completing preparation of the beverage.

20. The method of claim 19, further comprising:
vertically translating, with a mechanism of the device, the sensing unit of the device downwards from the idle position or the active position to a cleaning position for cleaning of the sensing unit; and
vertically translating, with the mechanism of the device, the sensing unit of the device upwards from the cleaning position to the idle position or the active position after cleaning the sensing unit.
